(19) United States
(12) Patent Application Publication
(10) Pub. No.: US 2024/0085879 A1
(43) Pub. Date: Mar. 14, 2024

(54) PROGRAM ANALYSIS ASSISTANCE APPARATUS, PROGRAM ANALYSIS ASSISTANCE METHOD, AND COMPUTER READABLE RECORDING MEDIUM

(71) Applicant: NEC Corporation, Minato-ku, Tokyo (JP)

(72) Inventor: Masafumi WATANABE, Tokyo (JP)

(73) Assignee: NEC Corporation, Minato-ku, Tokyo (JP)

(21) Appl. No.: 18/272,696

(22) PCT Filed: Jan. 22, 2021
(86) PCT No.: PCT/JP2021/002301

§ 371 Date: Jul. 17, 2023

(51) Int. Cl. G05B 19/05

(52) U.S. Cl. CPC G05B 19/058; G05B 2219/23317

(57) ABSTRACT

A program analysis assistance apparatus 10 includes: an instruction analyzing unit 11 that extracts, from the device control program, instructions and comments in which the registers are used as operands, and identifies the signal values output by the registers based on the extracted instructions; and a matching processing unit 12 that identifies the signal lines to which the registers are connected by matching the extracted comments by the instruction analyzing unit 11 and the identified signal values by the instruction analyzing unit 11, against rules defining relationships between signal lines, signal values, and keywords.

### TECHNICAL FIELD

The invention relates to a program analysis assistance apparatus and a program analysis assistance method for assisting the analysis of a program in a control system, and further relates to a computer readable recording medium that includes recorded thereon a program for realizing the program analysis assistance apparatus and the program analysis assistance method.

### BACKGROUND ART

Recent years have seen an increase in cyberattacks targeting control systems for power plants, manufacturing facilities in factories, etc. Such cyberattacks are unignorable; for example, a company would suffer from significant damage should a manufacturing facility in a factory stop due to a cyberattack. Furthermore, a large-scale blackout may occur should a facility in a power plant stop due to a cyberattack.

Thus, a measure is taken of constructing a virtual model corresponding to the control system and analyzing cyberattacks on the virtual model. In order to enhance the accuracy of the analysis, it is necessary to construct a virtual model that is as accurate as possible.

Incidentally, a control device called a programmable logic controller (PLC) is used in such a control system in order to control devices such as conveyors, electric motors, and cylinders (for example, see Patent Documents 1 and 2). In order to control various devices, the control device receives inputs of and outputs signals in accordance with a control program. Thus, in order to construct an accurate virtual model, connection information indicating the connections between the PLC and various devices is necessary. The connection information is information for identifying which signal line of which device a PLC register is associated with.

### LIST OF RELATED ART DOCUMENTS

### Patent Document

Patent Document 1: Japanese Patent Laid-Open Publication No. 2006-318504
Patent Document 2: International Publication No. 2014/064830

### SUMMARY OF INVENTION

### Problems to be Solved by the Invention

However, accurate connection information of a control system is usually not easy to acquire. For example, in a case in which a long period of time has passed since a control system was introduced, there may be no existing connection information. Furthermore, in a case in which an administrator of a control system outsourced the construction of the control system to another company, the administrator may not possess connection information.

While connection information can be acquired by manually analyzing the control program of the control device in such cases, the complexity of the control program would result in a lot of time and cost being spent to acquire connection information by analyzing the control program.

An example object of the invention is to provide a program analysis assistance apparatus, a program analysis assistance method, and a computer readable recording medium that overcome the above-described problem and could allow connection information to be easily acquired from a control program.

### Means for Solving the Problems

In order to achieve the above-described object, a program analysis assistance apparatus according to an example aspect of the invention, includes:
an instruction analyzing unit that extracts, from the device control program, instructions and comments in which the registers are used as operands, and identifies the signal values output by the registers based on the extracted instructions; and
a matching processing unit that identifies the signal lines to which the registers are connected by matching the extracted comments by the instruction analyzing unit and the identified signal values by the instruction analyzing unit, against rules defining relationships between signal lines, signal values, and keywords.

In addition, in order to achieve the above-described object, a program analysis assistance method according to an example aspect of the invention includes:
an instruction analyzing of extracting, from the device control program, instructions and comments in which the registers are used as operands, and identifying the signal values output by the registers based on the extracted instructions; and
a matching processing step of identifying the signal lines to which the registers are connected by matching the extracted comments by the instruction analyzing step and the identified signal values by the instruction analyzing step, against rules defining relationships between signal lines, signal values, and keywords.

Furthermore, in order to achieve the above-described object, a computer readable recording medium according to an example aspect of the invention is a computer readable recording medium that includes recorded thereon a program,
the program including instructions that cause a computer to carry out:
an instruction analyzing of extracting, from the device control program, instructions and comments in which the registers are used as operands, and identifying the signal values output by the registers based on the extracted instructions; and
a matching processing step of identifying the signal lines to which the registers are connected by matching the extracted comments by the instruction analyzing step and the identified signal values by the instruction analyzing step, against rules defining relationships between signal lines, signal values, and keywords.

### Advantageous Effects of the Invention

As described above, according to the invention, it is possible to acquire connection information easily from a control program.

### BRIEF DESCRIPTION OF THE DRAWINGS

FIG. 1 is a configuration diagram illustrating the schematic configuration of the program analysis assistance apparatus in the example embodiment.

FIG. 2 is a configuration diagram illustrating the configuration of the program analysis assistance apparatus in the example embodiment in detail.

FIG. 3(a) is a diagram illustrating one example of an analysis-target control program in the example embodiment, and FIG. 3(b) is a diagram illustrating comments and instructions in the control program illustrated in FIG. 3(a).

FIG. 4 is a diagram illustrating one example of a control system in which the control program illustrated in FIG. 3 is used.

FIG. 5 is a diagram illustrating one example of rules used to identify signal values in the example embodiment.

FIG. 6 is a diagram illustrating one example of rules used to identify signal lines in the example embodiment.

FIG. 7 is a flowchart illustrating operations of the program analysis assistance apparatus in the example embodiment.

FIG. 8 is a block diagram illustrating an example of a computer that realizes the program analysis assistance apparatus according to the example embodiment.

### EXAMPLE EMBODIMENT

### Example Embodiment

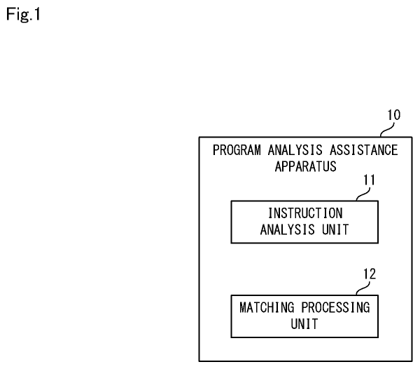

In the following, a program analysis assistance apparatus, a program analysis assistance method, and a program in an example embodiment will be described with reference to FIGS. 1 to 8.

[Apparatus Configuration]

First, the schematic configuration of the program analysis assistance apparatus in the example embodiment will be described with reference to FIG. 1. FIG. 1 is a configuration diagram illustrating the schematic configuration of the program analysis assistance apparatus in the example embodiment.

A program analysis assistance apparatus 10 in the example embodiment, which is illustrated in FIG. 1, is an apparatus that supports the analysis of a control program in a device control system. As illustrated in FIG. 1, the program analysis assistance apparatus 10 includes an instruction analysis unit 11 and a matching processing unit 12.

The instruction analysis unit 11 identifies, from a device control program, signal values that are output by registers. The matching processing unit 12 identifies, from the signal values identified by the instruction analysis unit 11, signal lines to which the registers are connected.

As described above, in the example embodiment, the program analysis assistance apparatus 10 can identify, from a control program, signal lines to which registers are connected; thus, a user can easily acquire connection information of a control system.

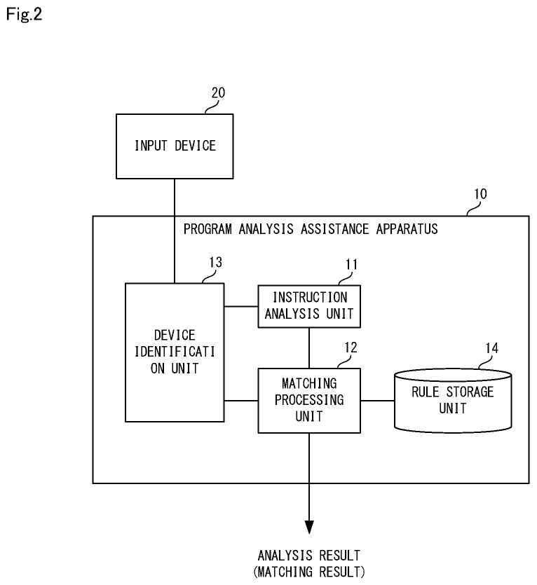

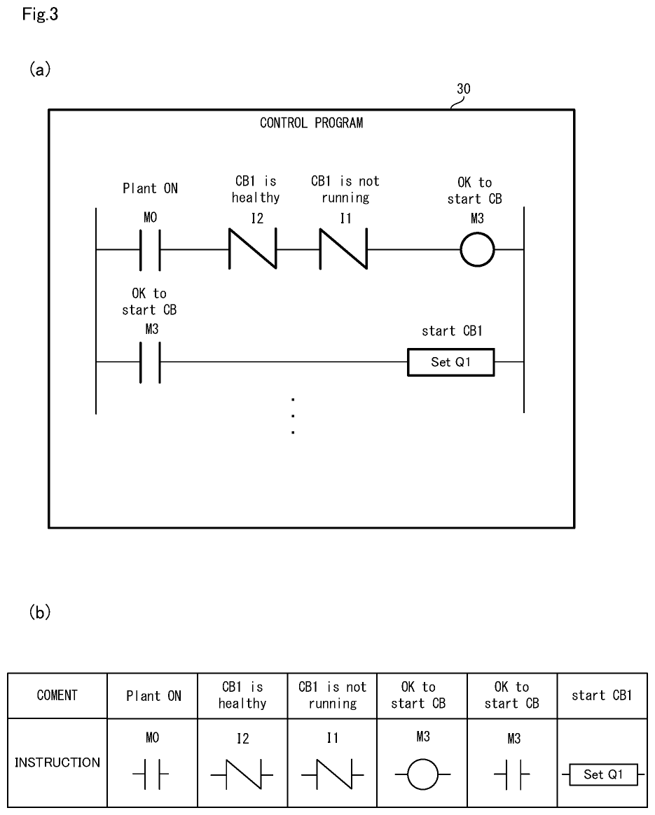

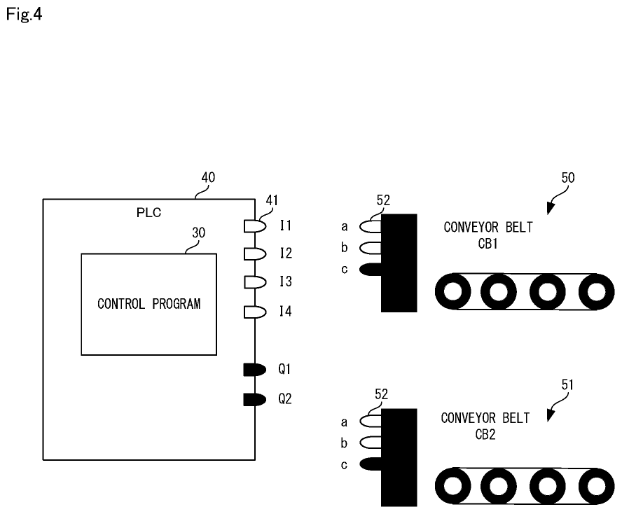

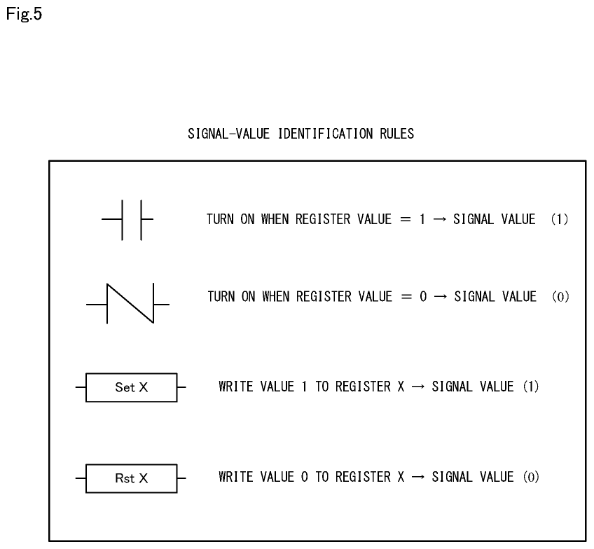

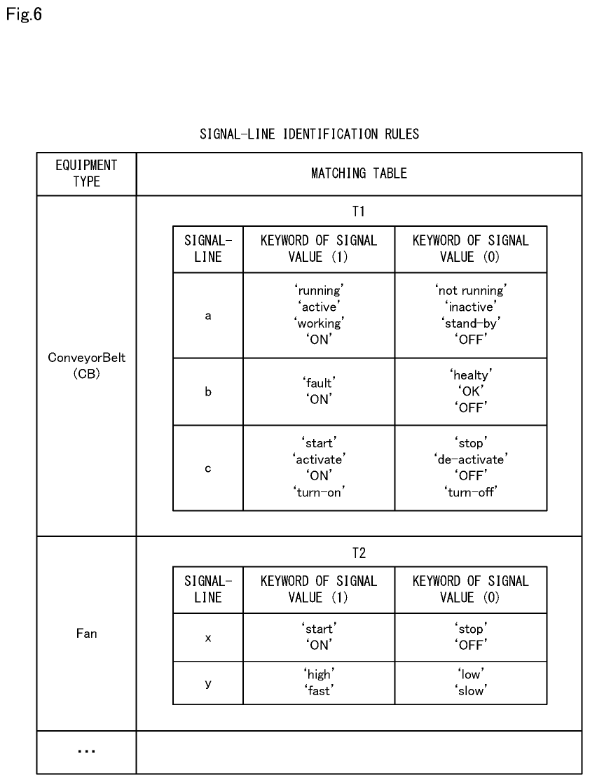

Next, the configuration and functions of the program analysis assistance apparatus in the example embodiment will be described in detail with reference to FIGS. 2 to 6. FIG. 2 is a configuration diagram illustrating the configuration of the program analysis assistance apparatus in the example embodiment in detail. FIG. 3(a) is a diagram illustrating one example of an analysis-target control program in the example embodiment, and FIG. 3(b) is a diagram illustrating comments and instructions in the control program illustrated in FIG. 3(a). FIG. 4 is a diagram illustrating one example of a control system in which the control program illustrated in FIG. 3 is used. FIG. 5 is a diagram illustrating one example of rules used to identify signal values in the example embodiment. FIG. 6 is a diagram illustrating one example of rules used to identify signal lines in the example embodiment.

As illustrated in FIG. 2, in the example embodiment, the program analysis assistance apparatus 10 includes a device identification unit 13 and a rule storage unit 14 in addition to the instruction analysis unit 11 and the matching processing unit 12 mentioned above. Furthermore, for example, the program analysis assistance apparatus 10 is connected to an input device 20 via a network.

The input device 20 inputs an analysis-target control program to the program analysis assistance apparatus 10. For example, the input device 20 may be an administration device for administering the control system, a terminal device of an administrator who administrates the control system, or the like.

The control program is a program for controlling devices such as conveyors, electric motors, and cylinders constituting the control system, and is executed by a control device such as a PLC. In the example embodiment, the control program input to the program analysis assistance apparatus 10 is a source program written in a programming language. The program illustrated in FIG. 3 is a specific example of the control program.

In the example illustrated in FIG. 3(a), a control program 30 is a ladder program to be executed by a PLC constituting the control system. The control program 30 is used by the PLC illustrated in FIG. 4 to control conveyor belts 50 and 51. In FIG. 4, “41” indicates terminals of the PLC 40, and “52” indicates conveyor belt terminals.

In FIGS. 3 and 4, “I1” to “I4”, “Q1”, and “Q2” indicate registers of the PLC 40, and are assigned to the terminals 41. While “M0” and “M3” in FIG. 3 also indicate registers of the PLC 40, these are internal memories and thus not assigned to the terminals 41. “CB” indicates a conveyor belt. Furthermore, in FIG. 4, “a” to “c” indicate signal lines of the conveyor belts 50 and 51, and are assigned to the terminals 52. While not illustrated in FIG. 4, the PLC terminals 41 and the terminals 52 of the conveyor belts 50 and 51 are actually connected.

Furthermore, as illustrated in FIG. 3(b), the control program 30 is constituted from instructions and comments. In each instruction, an operation executed based on the instruction and a register with which the operation processing is performed are specified. A register specified as such is typically referred to as an operand.

Specifically, in FIGS. 3(a) and 3(b), the instruction “| |” is one type of conditional decision instruction, and the rung (line) is true (conductive) when the value of the register specified as the operand is true (1), whereas the rung (line) is false (not conductive) when the value is false (0).

The instruction “|\|” is one type of conditional decision instruction, and the rung is true (conductive) when the value of the register specified as the operand is false (0), whereas the rung is false (not conductive) when the value is true (1). If a plurality of conditional decision instructions are disposed in series in a rung, the true/false value of the rung (whether the rung is conductive or not) is determined by the logical product of the execution results of all conditional decision instructions.

The instruction “0” is an output instruction, and sets the value of the register specified as the operand to true (1) when the rung in which the instruction is disposed is true (on) and sets the value of the register specified by the operand to false (0) when the rung in which the instruction is disposed is false (off).

The instruction “Set” is an output command, and sets the value of the register specified as the operand to true (1) when the rung in which the instruction is disposed is true (on). The instruction “Rst” is an output command, and sets the value of the register specified as the operand to false (0) when the rung in which the instruction is disposed is true (on).

In FIG. 3(a), the first rung (line) is true (on) when M0 is true (1), I2 is false (0), and I1 is false (0), and is otherwise false (off). True (1) is set to the value of M3 when the first rung is true (on), whereas false (0) is set to the value of M3 when the first rung is off. Furthermore, the second rung (line) is on when M3 is true (1), and is otherwise off. True (1) is set to the value of Q1 when the second rung is on.

M0 indicates the overall operation state of a production line in a factory, and the value thereof is set to true (1) if the production line is in operation and set to false (0) if the production line is not in operation (the program setting the value of M0 is not illustrated in FIG. 3). I2 indicates an out-of-order state input from the conveyor belt CB1, and the value thereof is set to true (1) if the conveyor belt is out of order and set to false (0) if the conveyor belt is healthy. I1 indicates an operation state input from the conveyor belt CB1, and the value thereof is set to true (1) if the conveyor belt is in operation and set to false (0) if the conveyor belt is not in operation.

M3 indicates an operation permission state of a conveyor belt, and the value thereof is set to true (1) if operation is to be permitted and set to false (0) if operation is to be prohibited. Q1 indicates an operation instruction to be output to the conveyor belt CB1, and the value thereof is set to true (1) if an instruction to operate is to be provided and set to false (0) if an instruction to stop is to be provided.

The comment “PLANT ON” provided to the instruction “M0+| |” in the first rung indicates that this instruction checks if the production line (PLANT) is in operation (ON). Furthermore, the comment “CB1 is healthy” provided to the instruction “I2+|\|” indicates that this instruction checks if CB1 is healthy.

In addition, the comment “CB1 is not running” provided to the instruction “I1+|\|” indicates that this instruction checks if CB1 is not in operation. Furthermore, the comment “OK to start CB” provided to the instruction “M3+∘” indicates that this instruction sets the operation permission state of CB1.

The comment “OK to start CB” provided to the instruction “M3+| |” in the second rung indicates that this instruction checks if operation of CB1 is permitted. Furthermore, the comment “Start CB1” provided to the instruction “Set Q1” indicates that this instruction instructs CB1 to operate.

The device identification unit 13 extracts registers and devices associated therewith from the control program. If the control program 30 illustrated in FIG. 3 (see FIG. 3(a)) is the analysis-target control program, the device identification unit 13 extracts the following registers and devices.
{register name: “I1”; device name: “CB1”}
{register name: “I2”; device name: “CB1”}
{register name: “Q1”; device name: “CB1”}

In the example embodiment, the instruction analysis unit 11 extracts, from the device control program, comments and instructions in which the registers are used as operands. Furthermore, based on the extracted instructions, the instruction analysis unit 11 identifies signal values output by the registers.

Specifically, when registers are extracted by the device identification unit 13, the instruction analysis unit 11 extracts instructions and comments relating to the extracted registers. If the device identification unit 13 has extracted the above-described registers from the control program 30, the instruction analysis unit 11 extracts instructions and comments relating to the registers I1, I2, and Q1 as shown below.
{I1: instruction (|\|)+comment (CB1 is not running)}
{I2: instruction (|\|)+comment (CB1 is healthy)}
{Q1: instruction (Set Q1)+comment (Start CB1)}

Furthermore, in the example embodiment, the instruction analysis unit 11 identifies signal values output by the registers by matching the extracted instructions against rules (hereinafter “signal-value identification rules”) in which, for each instruction, a corresponding signal value is defined in advance. The rules illustrated in FIG. 5 are specific examples of the signal-value identification rules. If the signal-value identification rules illustrated in FIG. 5 are used, the instruction analysis unit 11 identifies signal values as shown below in relation to the registers for which the above-described instructions and comments have been extracted. The signal-value identification rules are stored in the rule storage unit 14.
{I1: signal value (0)}
{I2: signal value (0)}
{Q1: signal value (1)}

The matching processing unit 12 identifies signal lines to which the registers are connected by matching the comments extracted by the instruction analysis unit 11 and the signal values identified by the instruction analysis unit 11 against rules (hereinafter “signal-line identification rules”) defining relationships between signal lines, signal values, and keywords.

Specifically, the matching processing unit 12 uses, as the signal-line identification rules, signal-line identification rules including signal lines, signal values, keywords, and also devices. Furthermore, the matching processing unit 12 matches, against the signal-line identification rules, the devices extracted by the device identification unit 13, the comments extracted by the instruction analysis unit 11, and the signal values also identified by the instruction analysis unit 11. The rules illustrated in FIG. 6 are examples of the signal-line identification rules. The signal-line identification rules are also stored in the rule storage unit 14.

For example, suppose that the analysis-target control program is the control program 30 illustrated in FIG. 3 (see FIG. 3(a)). In this case, because the device name “CB1” has been extracted in relation to the register I1, the matching processing unit 12 first selects table T1 from the signal-line identification rules. Next, the matching processing unit 12 matches, against table T1, the signal value (0) and the comment (CB1 is not running) extracted in relation to the register I1. As a result of the matching, because the keyword “not running” relating to the signal line (0) in table T1 matches, the matching processing unit 12 identifies the signal line a in relation to the register I1. Similarly, the matching processing unit 12 identifies the signal line b in relation to the register I2, and identifies the signal line c in relation to the register Q1.

Incidentally, a plurality of signal lines may be identified in relation to one register as a result of the matching. In such a case, the matching processing unit 12 calculates, for each of the plurality of signal lines, the probability of the signal line being connected to the register, and identifies the signal line for which the calculated probability is high as the signal line to which the register is connected.

For example, suppose that the following results were obtained as a result of matching being performed with respect to the register I2. In the following results, the number of cases in which the result was signal line b is more than the number of any other case, and the probability of the result being signal line b is 67%. Thus, the matching processing unit 12 identifies that the register I2 is connected to the signal line b.
I2: signal line b
I2: signal line b
I2: signal line c
I2: signal line b
I2: signal line cannot be identified
I2: signal line b

Subsequently, the matching processing unit 12 outputs, as analysis results, a list (matching results) including, for each register, a corresponding signal line identified as a result of the matching. The following is one example of analysis results. Furthermore, the output destination may be the administration device or the terminal device of the administrator serving as the input device 20.
{register name: “I1”; device name: “CB1”; signal line “a”}
{register name: “I2”; device name: “CB1”; signal line “b”}
{register name: “Q1”; device name: “CB1”; signal line “c”}

[Apparatus Operations]

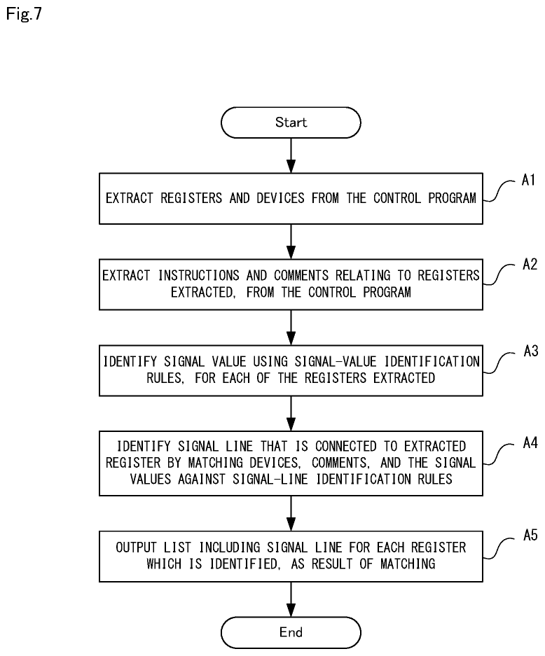

Next, operations of the program analysis assistance apparatus 10 in the example embodiment will be described with reference to FIG. 7. FIG. 7 is a flowchart illustrating operations of the program analysis assistance apparatus in the example embodiment. FIGS. 1 to 6 will be referred to as needed in the following description. Furthermore, in the example embodiment, a program analysis assistance method is implemented by causing the program analysis assistance apparatus 10 to operate. Accordingly, the following description of the operations of the program analysis assistance apparatus 10 is substituted for the description of the program analysis assistance method in the example embodiment.

First, it is assumed that an analysis-target control program has been input from the input device 20 to the program analysis assistance apparatus 10. The above-described control program illustrated in FIG. 3 is an example of the control program.

Then, as illustrated in FIG. 7, the device identification unit 13 extracts registers and devices associated therewith from the control program (step A1). Furthermore, the device identification unit 13 inputs information of the extracted registers and devices to the instruction analysis unit 11 and the matching processing unit 12.

Next, the instruction analysis unit 11 extracts, from the control program, instructions and comments relating to the registers extracted by the device identification unit 13 in step A1 (step A2). Furthermore, the instruction analysis unit 11 inputs information of the extracted comments to the matching processing unit 12.

Next, the instruction analysis unit 11 acquires the signal-value identification rules from the rule storage unit 14, and, for each of the registers extracted in step A1, identifies a signal value that the register outputs by matching the instructions extracted in step A2 against the acquired signal-value identification rules (step A3). Furthermore, the instruction analysis unit 11 also inputs information of the identified signal values to the matching processing unit 12.

Next, the matching processing unit 12 acquires the signal-line identification rules from the rule storage unit 14. Then, the matching processing unit 12 identifies, for each of the registers extracted in step A1, a signal line that is connected to the register by matching the devices extracted in step A1, the comments extracted in step A2, and the signal values identified in step A3 against the acquired signal-line identification rules (step A4).

Furthermore, if a plurality of signal lines have been identified in relation to one register as a result of the matching in step A4, the matching processing unit 12 calculates, for each of the plurality of signal lines, the probability of the signal line being connected to the register. Then, the matching processing unit 12 identifies the signal line for which the calculated probability is high as the signal line to which the register is connected.

Subsequently, the matching processing unit 12 outputs, to an output-destination device, a list (matching results) including, for each register, a corresponding signal line identified as a result of the matching (step A5).

### Effects of Embodiment

As described above, in the example embodiment, when a control program 30 as illustrated in FIG. 3(a) is input, the control program 30 is analyzed, and signal lines relating to instructions and comments included in the control program 30, i.e., signal lines to which registers are connected, are identified. Thus, according to the example embodiment, even if connection information of a control system does not exist, a user can easily acquire the connection information from a control program.

[Program]

It suffices for a program in the example embodiment to be a program that causes a computer to carry out steps A1 to A5 shown in FIG. 7. Also, by this program being installed and executed in the computer, the program analysis assistance apparatus 10 and the program analysis assistance method according to the example embodiment can be realized. In this case, a processor of the computer functions and performs processing as the instruction analysis unit 11, the matching processing unit 12, and the device identification unit 13.

In the example embodiment, the rule storage unit 14 may be realized by storing data files constituting the rule storage unit 14 in a storage device such as a hard disk provided in the compute. The rule storage unit 14 may be realized by a storage device of another computer.

The program according to the example embodiment may be executed by a computer system constructed with a plurality of computers. In this case, for example, each computer may function as one of as the instruction analysis unit 11, the matching processing unit 12, and the device identification unit 13.

[Physical Configuration]

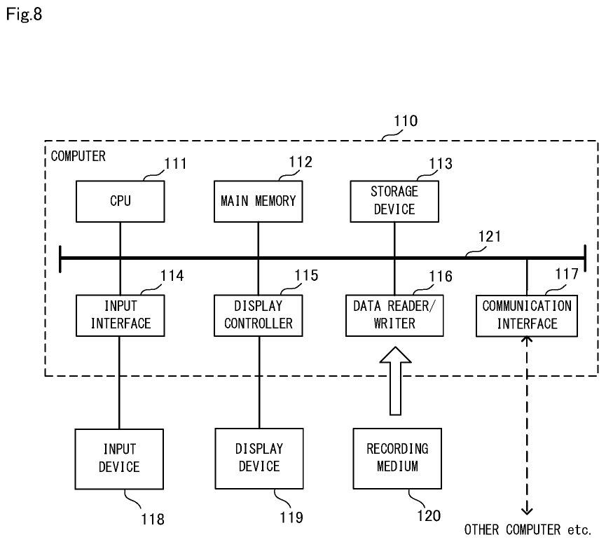

Using FIG. 8, the following describes a computer that realizes the program analysis assistance apparatus 10 by executing the program according to the example embodiment. FIG. 8 is a block diagram illustrating an example of a computer that realizes the program analysis assistance apparatus according to the example embodiment.

As shown in FIG. 8, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121. The computer 110 may include a GPU (Graphics Processing Unit) or an FPGA (Field-Programmable Gate Array) in addition to the CPU 111, or in place of the CPU 111. In this case, the GPU or the FPGA can execute the programs according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the program analysis assistance apparatus 10 according to the example embodiment can also be realized by using items of hardware that respectively correspond to the components, such as a circuit, rather than the computer in which the program is installed. Furthermore, a part of the program analysis assistance apparatus 10 according to the example embodiment may be realized by the program, and the remaining part of the program analysis assistance apparatus 10 may be realized by hardware.

A part or an entirety of the above-described example embodiment can be represented by (Supplementary Note 1) to (Supplementary Note 18) described below but is not limited to the description below.

(Supplementary Note 1)

A program analysis assistance apparatus comprising:
an instruction analyzing unit that identifies, from a device control program, signal values output by registers; and
a matching processing unit that identifies, from the identified signal values, signal lines that are connected to the registers.

(Supplementary Note 2)

The program analysis assistance apparatus according to Supplementary Note 1,
wherein the instruction analyzing unit extracts, from the device control program, instructions and comments in which the registers are used as operands, and identifies the signal values output by the registers based on the extracted instructions, and
the matching processing unit identifies the signal lines to which the registers are connected by matching the extracted comments and the identified signal values against rules defining relationships between signal lines, signal values, and keywords.

(Supplementary Note 3)

The program analysis assistance apparatus according to Supplementary Note 2,
wherein, if a plurality of signal lines have been identified in relation to one of the registers as a result of the matching, the matching processing unit calculates, for each of the plurality of signal lines, a probability of the signal line being connected to the one of the registers, and identifies a signal line for which the calculated probability is high as the signal line to which the register is connected.

(Supplementary Note 4)

The program analysis assistance apparatus according to Supplementary Note 2 or 3,
wherein the instruction analyzing unit identifies the signal values output by the registers by matching the extracted instructions against rules in which, for each instruction, an associated signal value is defined in advance.

(Supplementary Note 5)

The program analysis assistance apparatus according to any one of Supplementary Notes 2 to 4 further comprising:
a device identifying unit that extracts registers and devices associated therewith from the control program,
wherein the instruction analyzing unit extracts the instructions and the comments relating to the registers extracted by the device identifying unit,
the rules define relationships between devices, signal lines, signal values, and keywords, and
the matching processing unit matches, against the rules, the devices extracted by the device identifying unit, the comments extracted by the instruction analyzing unit, and the signal values identified by the instruction analyzing unit.

(Supplementary Note 6)

The program analysis assistance apparatus according to any one of Supplementary Notes 1 to 5,
wherein the device control program is a source program written in a programming language.

(Supplementary Note 7)

A program analysis assistance method comprising:
an instruction analyzing step of identifying, from a device control program, signal values output by registers; and
a matching processing step of identifying, from the identified signal values, signal lines that are connected to the registers.

(Supplementary Note 8)

The program analysis assistance method according to Supplementary Note 7,
wherein, in the instruction analyzing step, instructions and comments in which the registers are used as operands are extracted from the device control program, and the signal values output by the registers are identified based on the extracted instructions, and
in the matching processing step, the signal lines to which the registers are connected are identified by matching the extracted comments and the identified signal values against rules defining relationships between signal lines, signal values, and keywords.

(Supplementary Note 9)

The program analysis assistance method according to Supplementary Note 8,
wherein, in the matching processing step, if a plurality of signal lines have been identified in relation to one of the registers as a result of the matching, for each of the plurality of signal lines, a probability of the signal line being connected to the one of the registers is calculated, and a signal line for which the calculated probability is high is identified as the signal line to which the register is connected.

(Supplementary Note 10)

The program analysis assistance method according to Supplementary Note 8 or 9,
wherein, in the instruction analyzing step, the signal values output by the registers are identified by matching the extracted instructions against rules in which, for each instruction, an associated signal value is defined in advance.

(Supplementary Note 11)

The program analysis assistance method according to any one of Supplementary Notes 8 to 10 further comprising:
a device identifying step of extracting registers and devices associated therewith from the control program,
wherein, in the instruction analyzing step, the instructions and the comments relating to the extracted registers are extracted,
the rules define relationships between devices, signal lines, signal values, and keywords, and
in the matching processing step, the extracted devices, the extracted comments, and the identified signal values are matched against the rules.

(Supplementary Note 12)

The program analysis assistance method according to any one of Supplementary Notes 7 to 11,
wherein the device control program is a source program written in a programming language.

(Supplementary Note 13)

A computer readable recording medium that includes a program recorded thereon, the program including instructions that causes a computer to carry out:
an instruction analyzing step of identifying, from a device control program, signal values output by registers; and
a matching processing step of identifying, from the identified signal values, signal lines that are connected to the registers.

(Supplementary Note 14)

The computer readable recording medium according to Supplementary Note 13,
wherein, in the instruction analyzing step, instructions and comments in which the registers are used as operands are extracted from the device control program, and the signal values output by the registers are identified based on the extracted instructions, and
in the matching processing step, the signal lines to which the registers are connected are identified by matching the extracted comments and the identified signal values against rules defining relationships between signal lines, signal values, and keywords.

(Supplementary Note 15)

The computer readable recording medium according to Supplementary Note 14,
wherein, in the matching processing step, if a plurality of signal lines have been identified in relation to one of the registers as a result of the matching, for each of the plurality of signal lines, a probability of the signal line being connected to the one of the registers is calculated, and a signal line for which the calculated probability is high is identified as the signal line to which the register is connected.

(Supplementary Note 16)

The computer readable recording medium according to Supplementary Note 14 or 15,
wherein, in the instruction analyzing step, the signal values output by the registers are identified by matching the extracted instructions against rules in which, for each instruction, an associated signal value is defined in advance.

(Supplementary Note 17)

The computer readable recording medium according to any one of Supplementary Notes 14 to 16,
wherein the program including further instructions that causes the computer to carry out:
a device identifying step of extracting registers and devices associated therewith from the control program,
wherein, in the instruction analyzing step, the instructions and the comments relating to the extracted registers are extracted,
the rules define relationships between devices, signal lines, signal values, and keywords, and
in the matching processing step, the extracted devices, the extracted comments, and the identified signal values are matched against the rules.

(Supplementary Note 18)

The computer readable recording medium according to any one of Supplementary Notes 13 to 17,
wherein the device control program is a source program written in a programming language.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the invention, it is possible to acquire connection information easily from a control program. The invention is useful for various control systems using control programs.

### REFERENCE SIGNS LIST

10 Program analysis assistance apparatus
11 Instruction analysis unit
12 Matching processing unit
13 Device identification unit
14 Rule storage unit
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A program analysis assistance apparatus comprising:
at least one memory storing instructions; and
at least one processor configured to execute the instructions to:
identify, from a device control program, signal values output by registers; and
identify, from the identified signal values, signal lines that are connected to the registers.

2. The program analysis assistance apparatus according to claim 1,
further at least one processor configured to execute the instructions to:
extract, from the device control program, instructions and comments in which the registers are used as operands, and identifies the signal values output by the registers based on the extracted instructions, and
identify the signal lines to which the registers are connected by matching the extracted comments and the identified signal values against rules defining relationships between signal lines, signal values, and keywords.

3. The program analysis assistance apparatus according to claim 2,
further at least one processor configured to execute the instructions to:
if a plurality of signal lines have been identified in relation to one of the registers as a result of the matching, calculate, for each of the plurality of signal lines, a probability of the signal line being connected to the one of the registers, and identifies a signal line for which the calculated probability is high as the signal line to which the register is connected.

4. The program analysis assistance apparatus according to claim 2,
further at least one processor configured to execute the instructions to:
identify the signal values output by the registers by matching the extracted instructions against rules in which, for each instruction, an associated signal value is defined in advance.

5. The program analysis assistance apparatus according to claim 2 further at least one processor configured to execute the instructions to:
extract registers and devices associated therewith from the control program,
extract the instructions and the comments relating to the registers extracted by the device identifying means,
wherein the rules define relationships between devices, signal lines, signal values, and keywords, and
at least one processor configured to execute the instructions to:
match, against the rules, the devices extracted by the device identifying means, the comments extracted by the instruction analyzing means, and the signal values identified by the instruction analyzing means.

6. The program analysis assistance apparatus according to claim 5,
wherein the device control program is a source program written in a programming language.

7. A program analysis assistance method comprising:
identifying, from a device control program, signal values output by registers; and
identifying, from the identified signal values, signal lines that are connected to the registers.

8. The program analysis assistance method according to claim 7,
wherein instructions and comments in which the registers are used as operands are extracted from the device control program, and the signal values output by the registers are identified based on the extracted instructions, and
the signal lines to which the registers are connected are identified by matching the extracted comments and the identified signal values against rules defining relationships between signal lines, signal values, and keywords.

9. The program analysis assistance method according to claim 8,
wherein, if a plurality of signal lines have been identified in relation to one of the registers as a result of the matching, for each of the plurality of signal lines, a probability of the signal line being connected to the one of the registers is calculated, and a signal line for which the calculated probability is high is identified as the signal line to which the register is connected.

10. The program analysis assistance method according to claim 8,
wherein the signal values output by the registers are identified by matching the extracted instructions against rules in which, for each instruction, an associated signal value is defined in advance.

11. The program analysis assistance method according to claim 8 further comprising:
extracting registers and devices associated therewith from the control program,
wherein the instructions and the comments relating to the extracted registers are extracted,
the rules define relationships between devices, signal lines, signal values, and keywords, and
the extracted devices, the extracted comments, and the identified signal values are matched against the rules.

12. The program analysis assistance method according to claim 7,
wherein the device control program is a source program written in a programming language.

13. A non-transitory computer readable recording medium that includes a program recorded thereon, the program including instructions that causes a computer to:
identify, from a device control program, signal values output by registers; and
identify, from the identified signal values, signal lines that are connected to the registers.

14. The non-transitory computer readable recording medium according to claim 13,
wherein the computer
extracts, from the device control program, instructions and comments in which the registers are used as operands, and identifies the signal values output by the registers based on the extracted instructions, and
identifies the signal lines to which the registers are connected by matching the extracted comments and the identified signal values against rules defining relationships between signal lines, signal values, and keywords.

15. The non-transitory computer readable recording medium according to claim 14,
wherein the computer
if a plurality of signal lines have been identified in relation to one of the registers as a result of the matching, calculates, for each of the plurality of signal lines, a probability of the signal line being connected to the one of the registers, and identifies a signal line for which the calculated probability is high as the signal line to which the register is connected.

16. The non-transitory computer readable recording medium according to claim 14,
wherein the computer
identifies the signal values output by the registers by matching the extracted instructions against rules in which, for each instruction, an associated signal value is defined in advance.

17. The non-transitory computer readable recording medium according to claim 14,
wherein the program causes the computer to further:
extract registers and devices associated therewith from the control program, and
extract the instructions and the comments relating to the extracted registers,
the rules define relationships between devices, signal lines, signal values, and keywords, and
the computer matches, against the rules, the extracted devices, the extracted comments, and the identified signal values.

18. The non-transitory computer readable recording medium according to claim 13,
wherein the device control program is a source program written in a programming language.
